(19) United States
(12) Patent Application Publication
(10) Pub. No.: US 2020/0337252 A1
(43) Pub. Date: Oct. 29, 2020

(54) Garden Edging Connector

(71) Applicant: J. Todd Leach, Albert Lea, MN (US)

(72) Inventor: J. Todd Leach, Albert Lea, MN (US)

(21) Appl. No.: 16/807,712

(22) Filed: Mar. 3, 2020

Related U.S. Application Data
(60) Provisional application No. 62/837,463, filed on Apr. 23, 2019.

(51) Int. Cl. A01G 9/28; F16B 7/02

(52) U.S. Cl. CPC A01G 9/28; F16B 7/02

(57) ABSTRACT

A garden edging connector includes an elongated member that has a first end, a second end and a perimeter wall having an outer surface. A longitudinal axis of the elongated member extends through the first and second ends. The elongated member has a central area and defining a first portion and a second portion of the elongated member with the first portion including the first end and the second portion including the second end. The outer surface has a plurality of teeth extending upwardly therefrom wherein each of the first and second portions includes some of the teeth. The teeth each have an upper edge being angled away from the central area and each of the teeth has inner edge directed toward the central area. A juncture of associated ones of the upper and inner edges forms a sharp edge to engage garden edging.

### CROSS-REFERENCE TO RELATED APPLICATIONS

I hereby claim the benefit under 35 U.S.C. Section 119(e) of U.S. Provisional application 62/837,463 filed on Apr. 23, 2019.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to garden edging coupling device and more particularly pertains to a new garden edging coupling device for holding together garden edging sections such that the sections do not easily move relative to, and in particular away from, each other.

### (2) Description of Related Art Including Information Disclosed Under 37 CFR 1.97 and 1.98

The prior art relates to couplers that are used for holding garden and lawn edging together. This type of edging is typically comprised of a plastic or elastomeric material which will shrink and expand due temperature variations. As the edging shrinks and expands, sections thereof are pulled apart from each other as prior art couplers have not been sufficient in preventing these sections from disengaging from each other. Thus it is often required that the edging sections be moved and re-secured to each other to form a continuous and aesthetically pleasing structure.

### BRIEF SUMMARY OF THE INVENTION

An embodiment of the disclosure meets the needs presented above by generally comprising an elongated member that has a first end, a second end and a perimeter wall extending between the first and second ends. The perimeter wall has an outer surface. A longitudinal axis of the elongated member extends through the first and second ends. The elongated member has a central area and defining a first portion and a second portion of the elongated member with the first portion including the first end and the second portion including the second end. A plane of the central area is orientated perpendicular to the longitudinal axis. The outer surface has a plurality of teeth extending upwardly therefrom wherein each of the first and second portions includes some of the teeth. The teeth each have an upper edge being angled away from the central area and each of the teeth has inner edge directed toward the central area. A juncture of associated ones of the upper and inner edges forms a sharp edge.

An embodiment of the disclosure further includes a method of providing a first edging section and a second edging section. Each of the first and second edging sections includes a panel having a top edge and a bottom edge, and a tube that is attached to and extends along the top edge. The tube has an inner diameter dimension. A coupler assembly is provided which includes an elongated member having a first end, a second end and a perimeter wall extending between the first and second ends. The perimeter wall has an outer surface and a longitudinal axis of the elongated member extends through the first and second ends. The elongated member has a central area and defines a first portion including the first end and a second portion including the second end. A plane of the central area is orientated perpendicular to the longitudinal axis. The outer surface has a plurality of teeth extending upwardly therefrom wherein each of the first and second portions includes some of the teeth. The teeth each have an upper edge angled away from the central area and each of the teeth has an inner edge directed toward the central area. A juncture of each of associated ones of the upper and inner edges forms a sharp edge. The elongated member and teeth have a combined greatest outer diameter dimension is between 2% inches and 5% greater than the inner diameter dimension. The first portion of the coupler assembly is extended into the tube of the first section such that the first section is within 0.50 inches of the central area. The second portion of the coupler assembly is extended into the tube of the second section such that the second section is within 0.50 inches of the central area. The coupler assembly frictionally engages and inner surface of the tubes of the first and second sections to prevent their separation due to thermal expansion and contraction.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side isometric view of a garden edging connector and method according to an embodiment of the disclosure.

FIG. 2 is a side view of an embodiment of the disclosure.

FIG. 3 is a front view of an embodiment of the disclosure.

FIG. 4 is a front in-use view of an embodiment of the disclosure.

FIG. 5 is a cross-sectional view of an embodiment of the disclosure taken along line 5-5 of FIG. 4.

FIG. 6 is an isometric view of edging of an embodiment of the disclosure.

FIG. 7 is an enlarged cross-sectional view of an embodiment of the disclosure taken from the area “7” of FIG. 3.

### DETAILED DESCRIPTION OF THE INVENTION

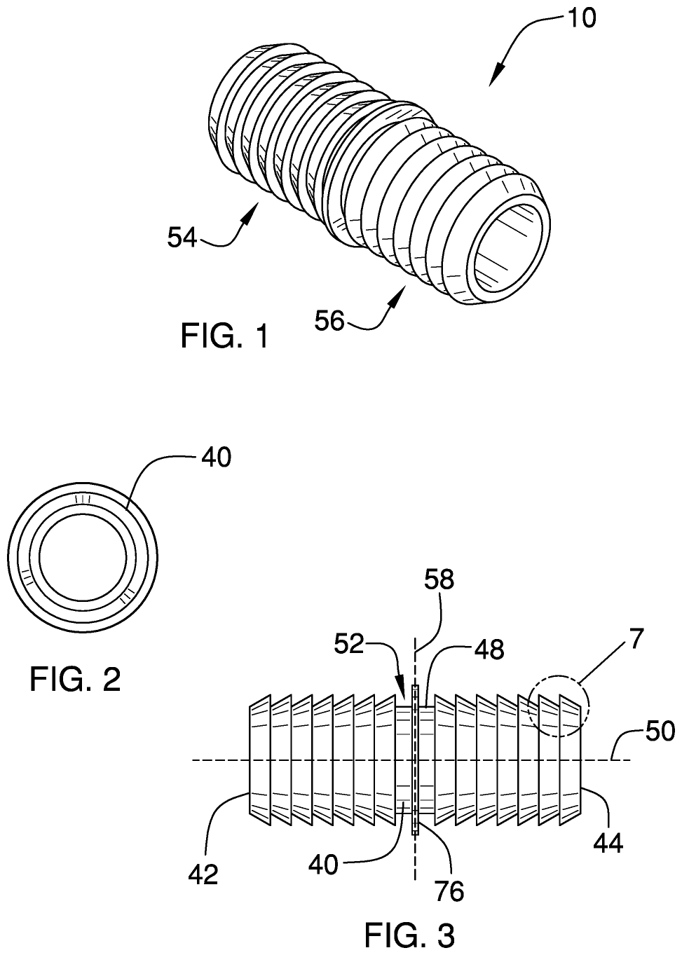

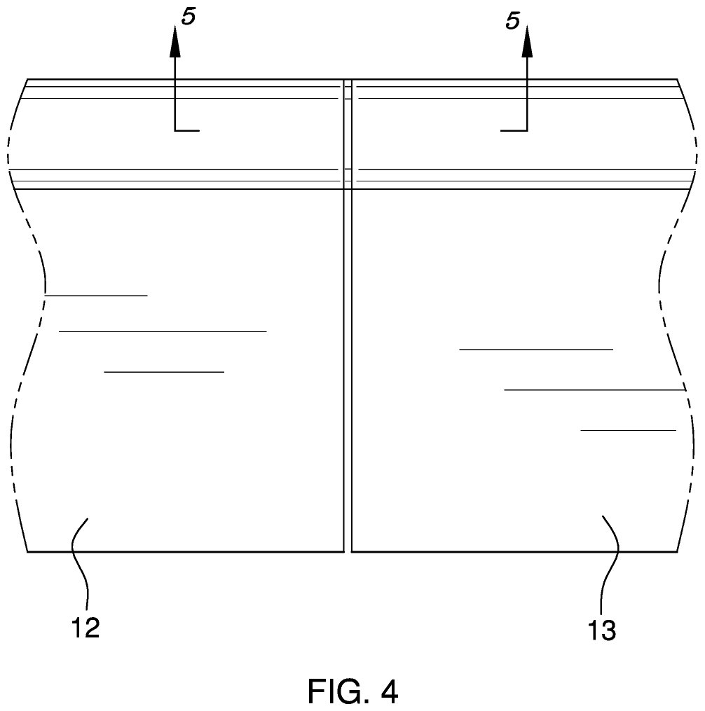

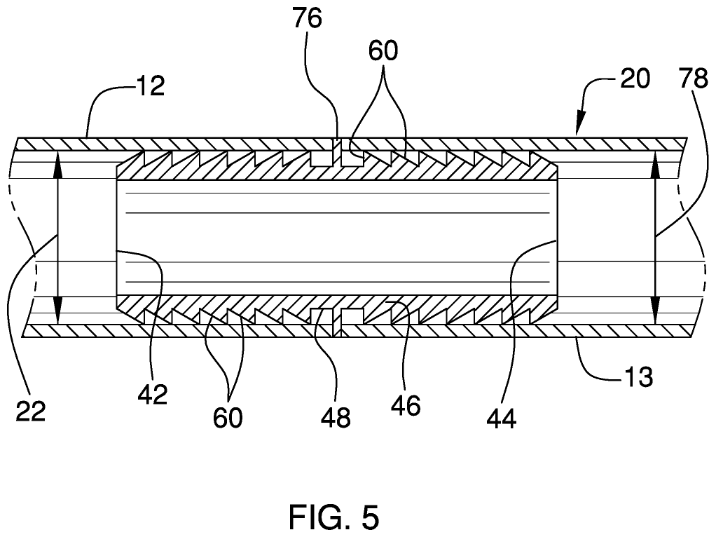

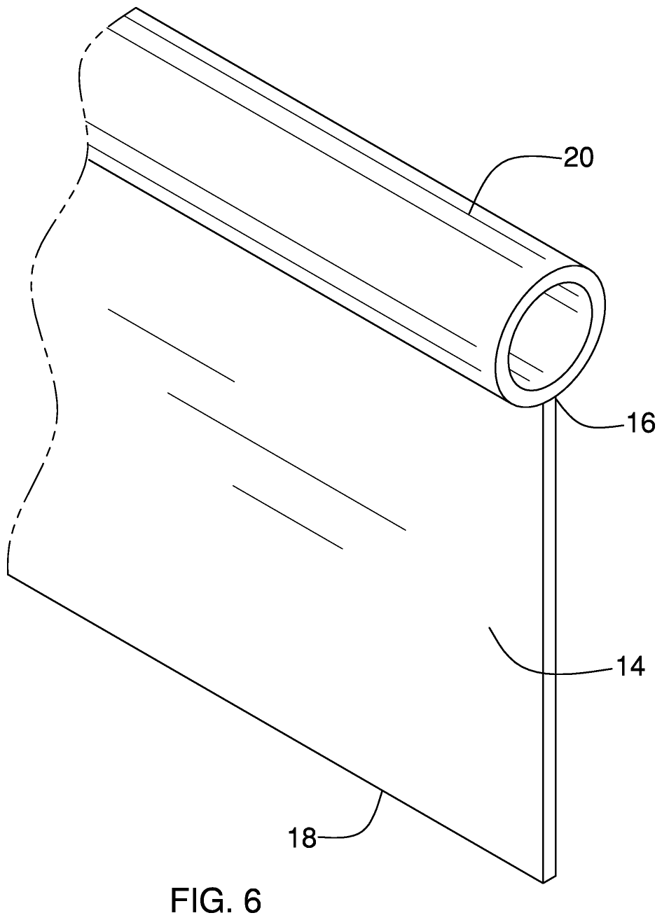

With reference now to the drawings, and in particular to FIGS. 1 through 7 thereof, a new garden edging coupling device embodying the principles and concepts of an embodiment of the disclosure and generally designated by the reference numeral 10 will be described.

As best illustrated in FIGS. 1 through 7, the garden edging connector 10 and method generally comprises the connecting together of a first edging section 12 and a second edging section 13 of garden edging. Garden edging typically includes a panel 14 having a top edge 16 and a bottom edge 18 and a tube 20 being attached to and extending along the top edge 16. The bottom edge 18 is embedded into soil such that an exposed portion of the panel 14 forms a wall, or barrier, between two areas such as a garden and a lawn. The tube 20 receives couplers wherein a pair of edging sections, i.e. the first edging section 12 and the second edging section 13, can be joined to provide the appearance of a continuous barrier. The tube 20 has an inner diameter dimension 78 which can vary depending on the manufacturer but which is typically between 0.60 inches and 1.25 inches. The first 12 and second 13 edging sections are typically comprised of plastic or elastomeric materials allowing them to bend as needed to form rounded barriers.

The garden edging connector 10 includes an elongated member 40 having a first end 42, a second end 44 and a perimeter wall 46 that extends between the first 42 and second 44 ends. The perimeter wall 46 has an outer surface 48 that may have a circular shape taken perpendicular to a longitudinal axis 50 of the elongated member 40 extending through the first 42 and second 44 ends. However, alternate shapes may be contemplated for reasons understandable below. The elongated member 40 has a central area 52 that defines a first portion 54 and a second portion 56 of the elongated member 40 wherein the first portion 54 includes the first end 42 and the second portion 56 includes the second end 44. More specifically, the central portion 56 is defined by a plane 58 orientated perpendicular to and intersecting the longitudinal axis 50 at a single point such that the plane 58 divides, and may bisect, the elongated member 12. However, it should be understood that the first 54 and second 56 portions may differ in length with respect to each other. The elongated member 40 may have a cylindrical tubular shape wherein the first 42 and second 44 ends are open.

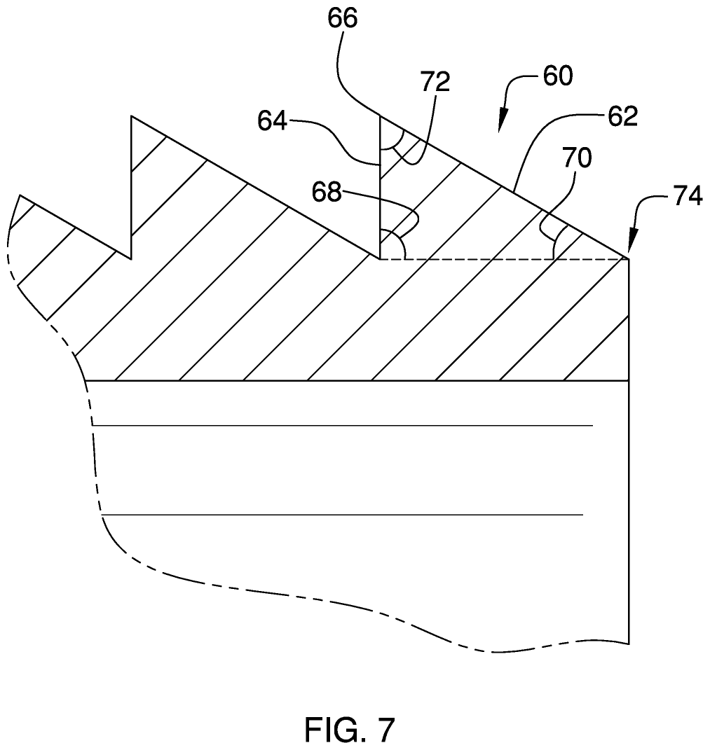

The outer surface 48 has a plurality of teeth 60 extending upwardly therefrom wherein each of the first 54 and second 56 portions include the teeth 60. The teeth 60 each have an upper edge 62 angled downwardly and away from the central area 52 of the elongated member 40 and an inner edge 64 directed upwardly from the outer surface 48. The inner edge may be angled toward the central area 52. A juncture 66 is defined between associated ones of the inner 64 and upper 62 edges and each juncture 66 forms a sharp edge when looking at a cross-section thereof taken along a plane extending along the longitudinal axis 50 as shown in FIG. 7. The sharp edge, or juncture 66, inhibits the removal of the connector 10 as will be further described below.

In some embodiments, the inner edges 64 are parallel to or are angled toward the plane 58 of the central area so that the inner edges 64 form an angle 68 with the outer surface that is equal to or less than 90°. The upper edges 62 in such an embodiment form an angle 70 with the outer surface 48 that is less than 45° and which may be as low at 8°. Thus, an angle 72 formed in each tooth at the juncture of associated ones of the upper 62 and inner 64 edges is equal to or less than 82°.

In an embodiment wherein the elongated member has a cylindrical shape, each of the teeth 60 may comprise an annular member, or continuous tooth, extending around and radially extending away from the elongated member 40. While a continuous annular member may be used as shown in the Figures, the annular member may have a plurality of breaks therein such that multiple rows of teeth 60 are formed, with the rows moving from the first 42 and second 42 ends toward the central area, wherein each row includes a plurality of teeth 60 spaced from each other. Generally however, the plurality of teeth 60 includes at least three of the teeth 60, laterally spaced from each other, on each of the first 54 and second 56 portions. The term “laterally” herein is being used to define a direction from the central area 52 and laterally to the first 42 and second 44 ends.

The elongated member 40 may have a length from the first end 42 to the second end 44 is that is between 2.0 inches and 4.0 inches and more typically with have a length that is between 2.5 inches and 3.5 inches. An outer diameter of the elongated member 40 will vary depending on the size of the tube 20 of the edging sections such that it can slide into the tube 20, thus, the elongated member 40 will typically have an outer diameter between 0.65 diameters and 1.25 inches.

The teeth each have a height between 0.02 inches and 0.15 inches as measured from the sharp edge 66 to the upper surface 48, particularly when the elongated member 40 has a cylindrical configuration. Specifically, the connector 10 will have a greatest diameter dimension, including the teeth, which is between 2% and 5% greater than the inner diameter dimension 78 of the tube 20 of the first 12 and second 13 edging sections. This typically equates to a greatest diameter dimension of between 0.02 inches and 0.05 inches greater than the inner diameter dimension 78 of the tube 20. It should be understood that teeth each have an insertion end 74, which is directed inward of the tube 20 during insertion of the elongated member 40 into the tube 20, having a minimum diameter dimension which is smaller than the inner diameter dimension 78 of the tube 20. The teeth 60 also may have a width, measured laterally, from between 0.10 inches to 0.25 inches.

The connector 10 may further include a stop 76. The stop 76 extends upwardly from the central area 52 of the elongated member 40 and may extend completely around the elongated member 40 or may comprise one or a plurality of discreet stops. When the elongated member 40 is extended into the tube 20 of the first 12 or second 13 edging sections, the stop 76 will prevent the elongated member 40 from extending too far into the tube 20. The stop 76 extends away from the outer surface a distance greater than the teeth 60 and in particular will extend at least 0.02 inches further away from the outer surface 48 than the teeth 60. More typically the stop 76 will form a greatest outer diameter dimension with the elongated member that is more than 0.15 inches greater than the inner diameter dimension 78 of the tube 20.

In use, the first portion 54 of the elongated member 40 is extended into the tube 20 of the first edging section 12 and the second portion 54 of the elongated member 40 is extended into the tube 20 of the second edging section 13. The first 12 and second 13 edging sections will be positioned within 0.5 inches of the central area 52 and will typically be abutted against each other or the stop 76, should the stop 76 be utilized. The shape of the teeth 60 and their height cause the teeth 60 to abut an inner surface of the tube 20. The angled direction of the teeth 60 allows the elongated member 40 to be easily extended into the tube 20 as it slides over the sharp edges 66 during insertion, but this angled direction prevents the removal of the elongated member 40 from the tube 20 as the sharp edges 66 dig into and frictionally bind the teeth 60 to the inner surface of the tube 20. This binding prevents the first 12 and second 13 edging sections from being removable from each other and resists gaps from forming between them during thermal contraction.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A garden edging coupler assembly configured to extend into and secure together two ends of edging material, said assembly comprising:
an elongated member having a first end, a second end and a perimeter wall extending between said first and second ends, said perimeter wall having an outer surface, a longitudinal axis of said elongated member extending through said first and second ends;
said elongated member having a central area and defining a first portion and a second portion of said elongated member, said first portion including said first end and said second portion including said second end;
a plane of said central area being orientated perpendicular to said longitudinal axis;
said outer surface having a plurality of teeth extending upwardly therefrom wherein each of said first and second portions includes some of said teeth, said teeth each having an upper edge angled downwardly and away from the central area, each of said teeth having an inner edge extending upwardly from said outer surface, each said inner edge being oriented perpendicular to said longitudinal axis or angled toward said central area, a juncture of associated ones of said upper and inner edges forming a sharp edge.

2. The garden edging coupler assembly according to claim 1, wherein said perimeter wall has an outer surface having a circular shape taken perpendicular to said longitudinal axis.

3. The garden edging coupler assembly according to claim 1, wherein each said upper edge forms an angle with said outer surface being less than 45°.

4. The garden edging coupler assembly according to claim 3, wherein an angle formed in each tooth at a juncture of associated ones of said upper and inner edges being less than 82°.

5. The garden edging coupler assembly according to claim 1, wherein an angle formed in each tooth at a juncture of associated ones of said upper and inner edges being less than 82°.

6. The garden edging coupler assembly according to claim 1, wherein each of said teeth comprises an annular member extending around said elongated member and radially extending away therefrom.

7. The garden edging coupler assembly according to claim 1, wherein said plurality of teeth includes at least three of said teeth positioned on each of said first and second portions.

8. The garden edging coupler assembly according to claim 1, wherein said elongated member has a length from said first end to said second end being between 2.0 inches and 4.0 inches.

9. The garden edging coupler assembly according to claim 1, wherein said elongated member has an outer diameter between 0.65 diameters and 1.0 inches.

10. The garden edging coupler assembly according to claim 9, wherein said teeth each have a height between 0.05 inches and 0.15 inches.

11. The garden edging coupler assembly according to claim 10, wherein each of said teeth has a width between 0.10 inches and 0.25 inches.

12. The garden edging coupler assembly according to claim 1, further including a stop being attached to and extending upwardly from said central area of said elongated member, said stop being configured to abut tubes of edging sections when said elongated member is extended into the tubes.

13. The garden edging coupler assembly according to claim 12, wherein said stop comprises an annular wall extending around said elongated member.

14. A method of joining edging material including the steps of:
providing a first edging section and a second edging section, each of said first and second edging sections including:
a panel having a top edge and a bottom edge;
a tube being attached to and extending along said top edge, said tube having an inner diameter dimension;
providing a coupler assembly including:
an elongated member having a first end, a second end and a perimeter wall extending between said first and second ends, said perimeter wall having an outer surface, a longitudinal axis of said elongated member extending through said first and second ends;
said elongated member having a central area and defining a first portion and a second portion of said elongated member, said first portion including said first end and said second portion including said second end;
a plane of said central area being orientated perpendicular to said longitudinal axis;
said outer surface having a plurality of teeth extending upwardly therefrom wherein each of said first and second portions includes some of said teeth, said teeth each having an upper edge angled away from the central area and each of said teeth having an inner edge directed toward said central area, a juncture of associated ones of said upper and inner edges forming a sharp edge;
said elongated member and teeth having a combined greatest outer diameter dimension being between 2% and 5% greater than said inner diameter dimension;
extending said first portion of said coupler assembly into said tube of said first section such that said first section is within 0.50 inches of said central area; and
extending said second portion of said coupler assembly into said tube of said second section such that said second section is within 0.50 inches of said central area.
